(19) United States
(12) Patent Application Publication
(10) Pub. No.: US 2014/0364272 A1
(43) Pub. Date: Dec. 11, 2014

(54) TRANSPORTATION DEVICE FOR SHABBAT OBSERVERS

(71) Applicant: MA'ALYUTA LTD., Tel-Aviv (IL)

(72) Inventors: Ron SHAPIRA, Tel-Aviv (IL); Elad HALEVI, Rishon- LeZion (IL); Shai COHEN, Modi'n (IL)

(21) Appl. No.: 13/911,668

(22) Filed: Jun. 6, 2013

(51) Int. Cl. B60W 10/08

(52) U.S. Cl. CPC B60W 10/08; B60W 2510/08; B60W 2510/09
USPC 477/3

(57) ABSTRACT

A system and method, the system including a transportation device configured to operate under at least a first condition and a second condition, wherein the transportation device is configured to operate without a human induced change in an electrical current during the second condition. a disengageable motor configured to operate the transportation device under the first condition and coupled to the transportation device, a disengageable energy storage device configured to operate the transportation device under the second condition and coupled to the transportation device, wherein the disengageable energy storage device may be automatically recharged by a charging device when the energy storage device is disengaged and, a mechanical processing unit for mechanically controlling the motion of the transportation device.

### FIELD OF THE INVENTION

The present invention relates generally to a transportation device for Shabbat observers.

### BACKGROUND OF THE INVENTION

Many observant Orthodox Jews refrain from certain activities on the Shabbat. In principle, Jewish law prohibits performing some forms of deliberate creative activity i.e., melakhah (Hebrew, plural: melakhoth) on Shabbat. According to tradition there are 39 super-categories (Av Melakhot) of prohibited activities, including kindling a fire, extinguishing a fire, building, demolishing, grinding, and threshing. Each super-category includes derived sub-categories (Tolda, plural: Toldot) of biblical and rabbinic prohibitions of various kinds. While there are myriad forbidden activities on Shabbat, all are traced back to one of the 39 above principal melakhoth. Different streams of Judaism view the prohibition on work in different ways.

Observant, Orthodox and Rabbinical authorities rule that turning electric devices on or off may be prohibited as a melakhah; however, authorities are not in agreement about exactly which one, including possibly kindling a fire, extinguishing a fire, building, or demolishing.

A common solution to the problem of using electricity on Shabbat involves preset timers for electric appliances, to turn them on and off automatically, with no human intervention on Shabbat itself. A theory behind this solution is that whereas the prohibition applies to the switching on and off of electric circuits during the Shabbat, it does not apply where the action begins earlier i.e., before the commencement of the Shabbat, even though it will be automatically completed during the Shabbat.

Moreover, in some instances, reprogramming a mechanical timer on the Shabbat may not constitute a violation of the Shabbat. For, example, where there is a significant time delay between an action and its result, a mechanical action resulting in the closing of an electric circuit later than planned, or opening it when it is already off later than planned, may be considered to have been one indirectly (Gramah) and thus may be permitted.

However, the direct operation of a switch or use of devices that directly or nearly directly cause changes in an electrically powered device, such as when a button is pushed, a motor is activated, or an infrared beam is tripped in the use of an elevator—are generally forbidden.

For observant Orthodox Jews living in high-rise apartments, the inability to take an elevator on the Shabbat, particularly to the higher floors can become a burden, particularly for the elderly, infirm or those with small children.

In or around 1964, a number of prominent rabbinical scholars reached a consensus regarding how an elevator should be designed to be acceptable to the observant Orthodox Jewish community for use on the Shabbat and Holidays.

Typically, the operation of a Shabbat elevator is such that the elevator operates automatically via set and pre-timed sequences, and without any obvious human intervention. These elevators operate as standard elevators during the week, but may switch to a Shabbat mode on the Shabbat and Holidays, and typically will stop automatically on every floor, or every other floor, either ascending and/or descending. Further, doors on the elevators during a Shabbat mode typically have their infrared sensors disengaged, and instead may be programmed such that the elevator doors will remain open for a preset amount of time before closing, the elevator continuing on with it pre-determined journey through the elevator shaft.

The efforts of many notwithstanding, there remain large segments of the Orthodox and Ultra-Orthodox Jewish population that continue to refrain from the use of Shabbat Elevators for any number of halachik (i.e., religious statute) or non-halachik (extra-statutory) reasons. A recent ruling from a renowned arbiter of Jewish law may have reenergized the debate over Shabbat elevators by raising additional concerns regarding the use of these elevators.

### SUMMARY OF THE INVENTION

It is therefore an object of the present invention to provide a system including a transportation device configured to operate under at least a first condition and a second condition, wherein the transportation device is configured to operate without a human induced change in an electrical current during the second condition, a disengageable motor configured to operate the transportation device under the first condition and coupled to the transportation device, a disengageable energy storage device configured to power the operation of the transportation device under the second condition and coupled to the transportation device, wherein the disengageable energy storage device may be automatically recharged by a charging device when the energy storage device is disengaged; and a mechanical processing

Furthermore, in accordance with some embodiments of the present invention, the energy storage device is a flywheel.

Furthermore, in accordance with some embodiments of the present invention, the system further includes a mechanical monitoring unit configured to mechanically monitor aspects of the transportation device.

Furthermore, in accordance with some embodiments of the present invention, the system further includes a continuous variable transmission for controlling a speed of the transportation device.

Furthermore, in accordance with some embodiments of the present invention, the disengageable energy storage device is configured to be recharged by a charging device when the disengageable energy storage device disengages.

Furthermore, in accordance with some embodiments of the present invention, the disengageable energy storage device is configured to be disengaged when the transportation device is at rest.

Furthermore, in accordance with some embodiments of the present invention, the disengageable energy storage device is configured to be recharged by a disengageable charging device after the transportation device has traveled a set distance.

Furthermore, in accordance with some embodiments of the present invention, the mechanical processing unit employs one or a plurality of indicators selected from the group consisting of oil pressure, water pressure, air pressure, and mechanisms.

Furthermore, in accordance with some embodiments of the present invention, a portion of the system is enclosed in a vacuum tank.

Furthermore, in accordance with some embodiments of the present invention, the system further includes a mechanical monitoring unit configured to mechanically monitor aspects of the transportation device, wherein the mechanical monitoring unit monitors speed and position of the transportation device using one or a plurality of indicators selected from the group consisting of water pressure, oil pressure, air pressure, and mechanical mechanisms.

There is further provided, in accordance with some embodiments of the present invention, a method including disengaging a motor configured to operate a transportation device under a first condition, engaging a disengageable energy storage device to operate the transportation device under a second condition, wherein the disengageable energy storage device may be automatically recharged by a charging device when the energy storage device is disengaged, and mechanically controlling the operation of the transportation device.

Furthermore, in accordance with some embodiments of the present invention, the energy storage device is a flywheel.

Furthermore, in accordance with some embodiments of the present invention, the method further includes mechanically monitoring the operation of the transportation device.

Furthermore, in accordance with some embodiments of the present invention, the method further includes controlling a speed of the transportation device.

Furthermore, in accordance with some embodiments of the present invention, the method further includes disengaging the disengageable the energy storage device when the transportation device is at rest.

Furthermore, in accordance with some embodiments of the present invention, the method further includes recharging the energy storage device by a charging device when the disengageable energy storage device disengages.

Furthermore, in accordance with some embodiments of the present invention, the method further includes recharging the disengageable energy storage device is recharged by a charging device after the transportation device has traveled a set distance or a set time has passed.

Furthermore, in accordance with some embodiments of the present invention, the mechanical processing unit employs one or a plurality of indicators selected from the group consisting of oil pressure, water pressure, air pressure, and mechanical mechanisms.

Furthermore, in accordance with some embodiments of the present invention, a vacuum tank creates at least a partial vacuum around the disengageable energy storage device.

Furthermore, in accordance with some embodiments of the present invention, the method further includes mechanically monitoring the operation of the transportation device, wherein the mechanical monitoring unit monitors speed and position of the transportation device using one or a plurality of indicators selected from the group consisting of water pressure, oil pressure, air pressure, and mechanical mechanisms.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1A is a schematic illustration of the mechanism of a Shabbat elevator according to an embodiment of the invention;

FIG. 1B is a schematic illustration of the mechanism of a Shabbat elevator according to an embodiment of the invention;

FIG. 2A is a schematic illustration of a method of employing a Shabbat elevator, according to an embodiment of the invention;

FIG. 2B is a schematic illustration of a method of employing a Shabbat elevator, according to an embodiment of the invention; and,

FIG. 3 is a schematic illustration of a method for operating a Shabbat elevator, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Embodiments of the present invention are directed at a transportation device for Shabbat and Jewish Holidays observers (hereinafter—Shabbat observers). Strict Shabbat observers refrain from using any electrical devices whose operation is modified or otherwise affected by the human user or users on the Jewish Sabbath and Jewish Holidays. In particular, strict Shabbat observers refrain from using any transportation devices which require their input to operate and which involve electric currents being created or changed as a result of a human intervention. Human intervention can be intentional, e.g., pushing of a button to call an elevator, and unintentional, e.g., additional weight of an elevator passenger that causes changes in the electric current necessary to operate the elevator.

While examples that are given hereinafter relate specifically to a Shabbat elevator, it is noted that embodiments of the present invention may relate to other transportation devices, such as, for example, escalators, scooters, vehicles, electric wheelchairs, dumbwaiters, moving sidewalks, etc., and are also covered by the scope of the present invention.

Embodiments of the present invention apply the use of a flywheel to store energy for use in the operation of an elevator and/or other transportation devices. Flywheels typically hold kinetic energy and that energy may be loaded into the flywheel by a motor and/or other charging devices. It is noted that embodiments of the present invention may relate to other energy storage devices and/or methods of holding and/or maintaining energy, kinetic or otherwise, but typically not electrical energy. It is also noted that embodiments of the present invention may relate to other methods of charging energy storage devices, in addition to the use of a motor.

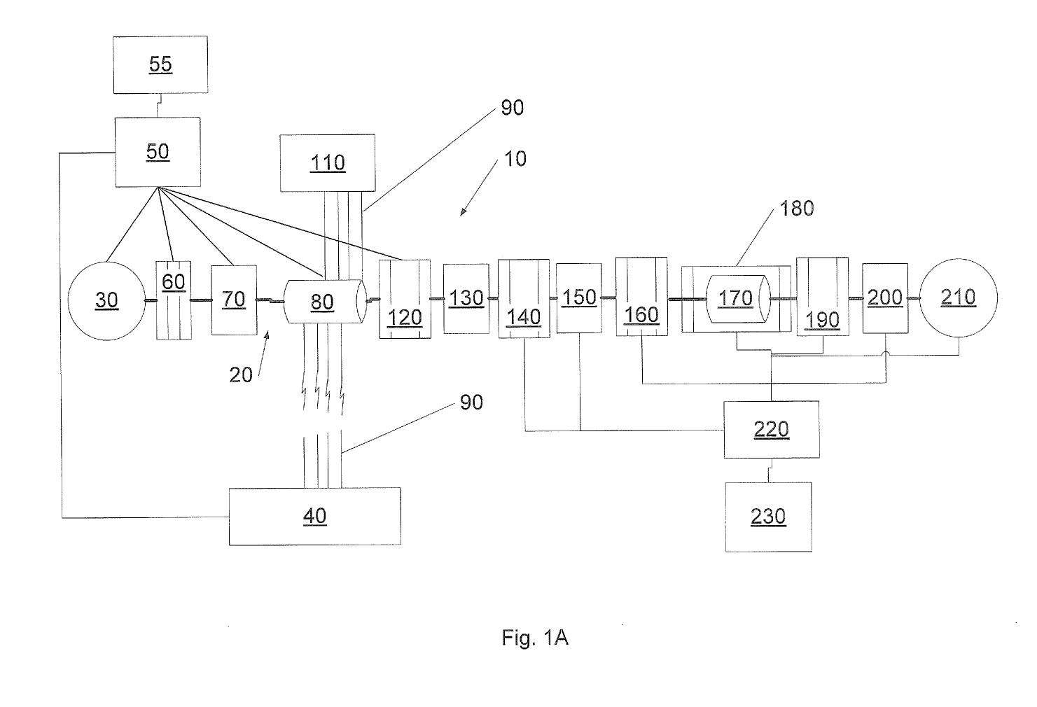

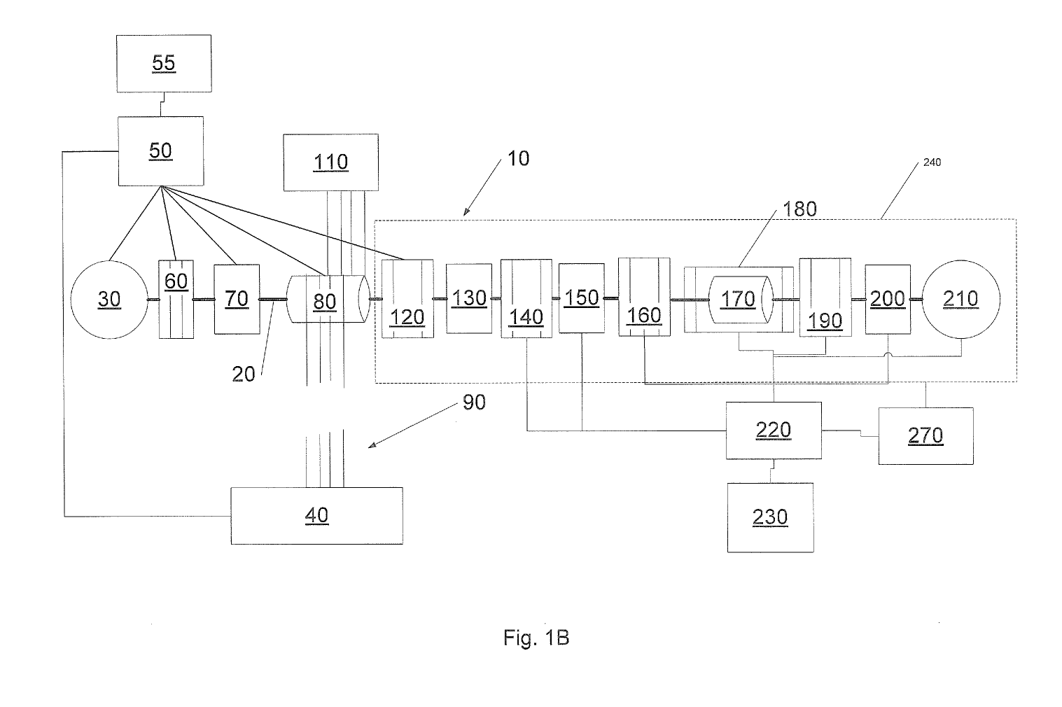

FIG. 1A is a schematic illustration of the mechanism of an elevator for Shabbat observers (hereinafter—Shabbat elevator) according to an embodiment of the invention.

A Shabbat elevator typically requires a separate mode, often an automatic or pre-set program mode in an effort to circumvent restrictions by Jewish Law (Halacha) on activities that are defined as creative work and to avoid directly causing that creative work to be done by the elevator. The Shabbat elevator is configured, in some examples, to operate continuously, the continuous operation being independent of whether there are actual riders and/or users for the elevator car at any particular time period.

According to an embodiment of the present invention, a Shabbat elevator's automatic or pre-set program mode is set to run from the start of the Shabbat, i.e., sundown on Friday afternoon, through the end of the Shabbat, i.e., the beginning of the night on Saturday evening, typically defined as the appearance of three medium sized stars. Opinions differ, however, as to when these time periods actually begin and some Shabbat observing Jews may extend the duration of the Shabbat, both on Friday afternoon and Saturday evening. The operation of a Shabbat elevator may take into account these observances as well.

As described above, the term Shabbat elevator may be a misnomer as the elevator may be configured to run on Jewish Holidays as well, particularly those holidays that share, with the Shabbat, some or all of the restrictions relating to creative work.

A Shabbat elevator programmed to run on a Jewish Holiday may have an automatic or pre-set program mode is set to run from the start of the Jewish Holiday, i.e., sundown on previous afternoon, through the end of the Jewish Holiday, i.e., the beginning of the night on that evening, typically defined as the appearance of three medium sized stars. In some embodiments of the invention, a Jewish Holiday may include a second day following the first, in which case the elevator may be programmed to run for two days on Shabbat mode. In some embodiments of the invention, a Jewish Holiday may include a third day following the first two (i.e., where one of the three days is a Shabbat) in which case the elevator may be programmed to run for three days on Shabbat mode.

According to an embodiment of the present invention, a Shabbat elevator may be configured to stop on every floor, or on specific floors automatically without user input. The buttons for calling and directing the elevator may be disengaged. In some examples, electronic eye systems, infrared systems and touch sensitive systems may be disengaged. Other command and control components of an elevator, e.g., those systems which measure the combined weight of the passengers and the car by way of electrical components such as sensors, may be disengaged.

A Shabbat elevator according to an embodiment of the present invention, may have at least two modes: a Shabbat mode, wherein all or some of the aforementioned systems are disengaged, as well as a non-Shabbat mode, wherein the elevator runs with all or most of its systems engaged. The non-Shabbat mode is essentially the standard operation of an elevator.

According to Talmudic law, there are 39 separate super-categories of creative work that are forbidden on the Shabbat. Rabbinic Judaism has, over the centuries, interpreted these categories as relevant to daily living. As such, one or more may relate to the operation of an elevator on the Shabbat. The laws of the Shabbat are complex and there are categorizations, sub-categorization and even further distinctions of prohibited activities on the Shabbat resulting in a myriad of legal distinctions for each and every action on the Shabbat such that depending on the circumstances, different activities may be allowable within the hierarchy of prohibited activities when necessary

The exact source and nature of the prohibition of using an electrical current on the Shabbat notwithstanding, the accepted practice generally prohibits the use of electricity on Shabbat even when no light or heat is generated. Some streams of Judaism take the prohibition of work on the Shabbat very strictly.

When an elevator ascends with the additional weight of one or more individuals, an additional electrical current may be required to empower the motor raising the elevator car. This addition of electrical may be seen as violation of the Shabbat. However, under some conditions, as long as the individual does not interact with any of the elevators controls or sensors they may not be in violation of the Shabbat, according to some opinions.

And, when an elevator descends, it may be assumed that the additional weight of the added individual in the elevator car is helping the motor in the descent. If the added additional body is viewed as being part of the descent system, then, when the elevator stops on a floor and an automatic electrical system is activated, the individual may be perceived as activating, in part, those electronic systems. In some instances, particularly in larger commercial elevators, the increased weight of an individual in an elevator, as the elevator descends, may introduce a decrease in the electric current to the motor. In some examples, a descending elevator may have sufficient weight to descend on its own, with the associated motors, in some examples, being turned into generators as the movement of the elevator drives the motor faster than its intended design and may return electricity back to the electrical grid. This may be halachikally problematic.

There may be issues concerning the added weight and the added strain on a motor when an elevator is traveling downward with people in the compartment. In these instances, when the elevator is traveling downward, elevator load change may cause a change in my elevator procedures and therefore switches (electric) and various controls are triggered at different times—a potentially prohibited action on the Shabbat.

A Shabbat elevator may be designed to overcome these and other concerns regarding the use of electricity on the Shabbat by automating the system and making all the components of the system operate independent of the people using the system. This Shabbat elevator may be a halachikly viable option for even those that stringently keep the Shabbat. Further, a Shabbat elevator may be designed such that the operation of the elevator, while ferrying passengers, is without the direct use or manipulation of an electric current, rather by using mechanical energy. The mechanical energy may, however, come about by the use of an electric current, the use of the electric current, however, independent of Shabbat observing user of the elevator. In some embodiments of the invention, the use of an electric current for recharging a mechanical source of energy may be without human intervention and may take place periodically and not while the elevator is ferrying a Shabbat observing passenger.

Typically, a Shabbat elevator according to an embodiment of the present invention may be operated, on a day that is not Shabbat or a Jewish Holiday, by a standard propulsion system and an electrical command system. These systems may be the same or similar to the systems that run the elevator when the Shabbat elevator is not in a Shabbat mode.

A selector (e.g., a switch) between Shabbat mode and a standard mode may be manual, automatic or semi-automatic. When selecting the Shabbat mode, the switch may engage the Shabbat mode components of the system, as described, for example, below. In some embodiments of the invention, the switch between Shabbat mode and the standard mode may allow the components of the standard mode to continue to be engaged and/or operate. The continued engagement and/or operation of the standard mode components may include a disconnection from the power source used during the standard mode.

A drive shaft 20 of a Shabbat elevator system 10. Drive shaft 20 includes a motor 30. In some embodiments, motor 30 may be electrically powered. In some embodiments, motor 30 may be powered by other means. In some embodiments, motor 30 may be a standard motor employed by an elevator. In some embodiments, motor 30 may be a machine-room-less motor (MRL). In some embodiments, motor 30 may be configured to move and or otherwise control the movement of elevator car 40.

Shabbat elevator system 10 may allow the use of the elevator on the Shabbat by orthodox, ultra orthodox or otherwise strict Shabbat observant Jews without creating a situation of violation of one or more of the prohibited creative actions described heretofore, each of the actions being considered desecration of the Shabbat.

Shabbat elevator system 10 may allow for the disconnecting and inactivity of the standard propulsion system used on a weekday, i.e., a non Shabbat or non Jewish Holiday. In some embodiments the disconnection between the standard propulsion systems—e.g., a motor—may be an electrical disconnection of the propulsion system, and/or also a physical separation of the motor or other propulsion components from drive shaft 20. This disconnect will not allow the operation of the ordinary system which use is deemed a desecration of the Shabbat by poskim (i.e., arbiters of Jewish law).

In some embodiments of the invention (e.g., in a Shabbat mode), an elevator car 40 may be transported upwards and downwards by the accumulated mechanical energy of a flywheel, a flywheel energy storage device, or other non-electrical, mechanical or otherwise non-electrical energy storage devices such as those that can store kinetic or potential energy.

While the elevator car is resting, i.e., when the elevator is stationary at a floor or building level within a building, house, boat, or other structure containing a Shabbat elevator, the energy storage device may be reloaded with kinetic, or other non-electrical, mechanical or otherwise non-electrical energy by an electric motor and/or charging device, or alternative method. When the elevator car begins, or in some embodiments of the invention, just before the elevator begins, to move again, a trip command by a processing unit may mechanically re-engage the energy storage device to drive shaft 20 and provide energy for and/or facilitate the movement of the elevator. The energy storage device may allow for the movement of the elevator car with the immediate availability of mechanical energy, or other forms of non-electrical energy.

In some embodiments of the invention, a mechanical processing unit and/or a mechanical monitoring unit may allow for the change in arrival times of the Shabbat elevator to different floors, due, for example, to changes in passenger weight, friction, and or other factors, without changing electrical switches and without the desecration of the Shabbat. The mechanical monitoring device may monitor aspects of the Shabbat elevator's ascent, descent or other aspects related to the travel and/or use of the Shabbat elevator

The motor may be controlled by a processing unit 50. Processing unit 50 may control other components of drive shaft 20. Processing unit 50 may be in communication with one or a plurality of sensors 55. Sensors 55 may detect speed, obstructions, height of the elevator, current weight of the elevator, location of the elevator, and other characteristics of the elevator and its position.

Shabbat elevator system 10 may include safety systems that are standard on typical elevators. Shabbat elevator system 10 may include different, additional or fewer safety systems that are standard on elevators. The safety systems may be operated without the need for an electrical current. In some embodiments of the invention, when a safety system is used to preserve human life and limb, it may be operated with an electrical current. In some embodiments of the invention, the safety system may be operated off-line, e.g., in a standby mode without the use of electrical current, by may be actively used with the use of electrical current.

Motor 30 on drive shaft 20 may be configured to exert command and/or control over elevator car 40 when an engagement mechanism for engagement and/or disengagement such as, for example a hydraulic pump or a clutch (heretofore referred to as a clutch) 60 is engaged. Clutch 60 may engage and disengage motor 30 to drive shaft 20 and or other components within Shabbat elevator system 10, such that at least motor 30 turns drive shaft 20 while clutch 60 is engaged and motor 30 does not turn drive shaft 20 while clutch 60 is not engaged.

In some embodiments, Shabbat elevator system 10 may include brake 70. Brake 70 may be a drum-type brake that may be actuated by spring force and held open electrically, mechanically or otherwise. Brake 70 may be a disc type. Brake 70 may include brake shoes or other brake types. In some embodiments, other brake systems may also be included in Shabbat elevator system 10. Brake 70 may be an electromagnetic braking device. Brake 70 may be another type of braking device.

Brake 70 may be used during Shabbat mode, and, in some embodiments of the invention, a separate brake system may be used in addition to or in lieu of brake 70 while elevator car 40 is running in Shabbat mode. Brake 70 may be mounted on the elevator drive shaft 20 or at another location such as reverse direction mechanism.

In some embodiments, Shabbat elevator system 10 may include sheave 80. Sheave 80 may be a pulley with a grooved rim surface to provide for cables 90. Sheave 80 may be positioned at the top of an elevator shaft. Sheave 80 may be configured so that cables 90 are gripped by the grooved rim surface. Sheave 80 may rotate in response to a force from motor 30 or other components of Shabbat elevator system 10, including flywheel 170 for storing mechanical and/or kinetic energy. In some embodiments, flywheel 170 may be a mechanical and rechargeable battery. In some embodiments, a mechanical and rechargeable battery may be used in lieu of flywheel 170. In some embodiments of the invention, other energy storage devices may be used. In some embodiments of the invention, the energy storage devices do not store electrical energy but may store kinetic and/or other forms of energy.

Cables 90 may be configured to be coupled to elevator car 40 and counterweight 110. The depiction of the counterweight in the figures is for descriptive purposes only and does not necessarily reflect the position of the counterweight vis-à-vis the elevator, the elevator shaft or any of the components of the Shabbat elevator system.

Cables may be coupled to a hitch plate on top of elevator car 40 or may be coupled to an underslung, below elevator car 40. In some embodiments of the invention, sheave 80 may achieve sufficient friction using reinforced rubber bands. Other combinations of devices for achieving sufficient friction in the grooves of the sheave may also be used.

In some embodiments, cables 90 may be made from one or a plurality of steel cables. The steel may be wound around each other. In some embodiments, other materials may also be used in constructing cables 90. In some embodiments, cables 90 may be chains. In some embodiments, cables 90 may have a jute core.

In some embodiments of the invention, grooves in sheave 80 may be configured such that the weight of elevator car 40 and counterweight 110 deform cable 90 as it passes through the grooves, providing, in some examples substantial friction. The friction may hold cables 90 in place as they are within the grooves of sheave 80 and rotated with and/or in conjunction with sheave 80.

Shabbat elevator system 10 may, in some embodiments, include one or a plurality of cables 90. In some embodiments of the invention, Shabbat elevator system 10 may include at least two or more cables. In some embodiments of the invention, the number of cables may be dictated by standards, regulations and/or other concerns. In some embodiments of the invention, the standard number of cables may be between 2 to 8 cables. In some embodiments, there may be fewer or greater number of cables. In some embodiments of the invention, one cable 90 may be sufficient to raise and lower and/or otherwise transport elevator car 40, but is typically not allowed by regulatory systems or by convention.

In some embodiments, Shabbat elevator system 10 may include a compensation system. The compensation system may include a separate set of cables 90, or in some embodiments of the invention, one or a plurality of chains attached to the bottom of counterweight 110 and the bottom of the elevator car 40.

In some examples, the compensation system may reduce the required power of the motor of elevator car 40, by compensating for a differing load of cable 90 between the sheave at the top of an elevator shaft and elevator car 40. If the difference of the load is too high, there may be problems with the friction and grip of cables 90. For example, if elevator car 40 is at, or near, the top of the elevator shaft, there may only be a short length of cable 90 above the elevator car, whereas there would be a long length of cable below the elevator car. At the same time, there would be a short length of cable for counterweight 110 at the bottom of the elevator shaft, and a longer length of cable 90 connected to a top portion of counterweight 90 toward the top of the elevator shaft. In this situation, there may be an additional pulley 80 in a pit at the bottom of the elevator shaft, below the elevator, to guide cables 90.

In some embodiments, Shabbat elevator system 10 may include a landing system. The landing system may inform the elevator as to its relative position within the elevator shaft.

Shabbat elevator system 10 according to an embodiment of the invention may include a Shabbat mode clutch 120, which may be configured such that, when motor 30 is engaged, Shabbat mode clutch 120 disengages the Shabbat mode, and, when the Shabbat elevator system is in Shabbat mode, Shabbat mode clutch 120 engages the Shabbat mode and disengages motor 30.

Shabbat elevator system 10 according to an embodiment of the invention may include a directional unit 130. Directional unit 130 may be a mechanical mechanism for reversing the direction of the travel of elevator car 40 when Shabbat elevator system 10 is in the Shabbat mode. In some embodiments of the invention there may be in addition or in lieu of directional unit 130 a forward and a reverse clutch.

Shabbat elevator system 10 according to an embodiment of the invention may include a coupling clutch 140. Coupling clutch 140 may be configured to connect directional unit 130 with other components of Shabbat elevator system 10 while Shabbat elevator system 10 is in the Shabbat mode.

Transmission 150 may be a continuous variable transmission (CVT). In other embodiments, transmission 150 may be another type of transmission that may use belts, gears and/or other components. In other embodiments of the invention, another control means may be used to control and/or vary the speed, acceleration and other properties of elevator car 40. Transmission 150 may include a belt that runs around a pair of variable diameter pulleys. The belt may be composed of a metal, an alloy, a composite, a polymer or another material. In some examples, the pair of variable diameter pulleys may include a primary or drive pulley and secondary or driven pulley. The pulleys may be coupled sheaves. The driven or primary pulley is connected to the engine (input shaft) and the secondary or driven pulley is connected to the output shaft.

The variable-diameter pulleys may each be shaped like a pair of opposing cones. The gear ratio may change as the primary or driving pulley opens and the secondary or driven pulley closes, or vice versa. The opening and closing of the primary and secondary pulleys, e.g., the controlling of the width of the pulleys allows for the metal belt to rotate on an ever changing and infinitely modifiable radius, providing for infinitely variable gear ratios from the input to the output. In some examples, a piston may receive and/or hydraulic pressure resulting in a changing of the width of the pulleys or clutches. In some examples, transmission 150 may be a Hydrostatic transmission that uses a variable displacement pump and a hydraulic motor.

Transmission 150 may be configured to control and coordinate the rotational speed between flywheels, e.g., flywheel 170 and sheave 80. Transmission 150 may provide for the transmission of power from a motor or mechanical motivator to elevator car 40. In some embodiments of the invention, transmission 150 may be configured to operate, be engaged, disengaged or otherwise manipulated via purely mechanical means. In some embodiments of the invention, transmission 150 may be configured to operate, be engaged, disengaged or otherwise manipulated via non-electrical means.

Drive clutch 160 may be a mechanically controlled clutch and may open or close due to mechanical inputs. Drive clutch 160 may disengage flywheel 170 from the other components of Shabbat elevator system, wherein flywheel 170 is not connected to sheave 80. The disengagement of flywheel 170 may be employed when elevator car 40 is stationary or braked. In some embodiments of the invention, a torque convertor may also be employed, and the torque converter may allow the flywheel to continue spinning but with less strain on sheave 80 and or other components of Shabbat elevator system

Flywheel energy storage potential may be calculated as proportional to mass moment of inertia or the square of rotational speed. The speed of a flywheel may be limited by the strength-to-density ratio of a rotor and/or flywheel material. Flywheel 170 may be configured to retain kinetic energy to power the transportation of elevator car 40 on the Shabbat without the need for additional electrical current input while elevator car 40 is in transit. Flywheel 170 may be a rotating mechanical device, in some embodiments between 400 to 1000 mm in diameter, e.g., 700 mm in diameter. The rotating flywheel may store rotational energy, in some examples due to a significant moment of inertia. Additional energy may be periodically transferred to flywheel 170 by applying torque to the system and increasing the rotational speed of flywheel 170.

Flywheel 170 may be made from various materials, (e.g. carbon fiber, steel, polymer and composite materials). In some embodiments, flywheel 170 may be rotated on conventional bearings. In some embodiments, magnetic bearings may be used that support a load using magnetic levitation and without physical contact or additional friction within a flywheel system. In some embodiments, high-temperature superconductor (HTSC) bearings may also be used. Flywheel 170 may rotate at speeds up to and including, and/or surpassing, for example, 66,000 revolutions per minute (RPM). The moment of inertia around an axis of rotation of the wheel and the speed of rotation may determine the amount of energy stored in flywheel 170. Drag on the flywheel and increased friction caused by the rotation of the earth may be minimized by aligning the axis of rotation of flywheel 170 parallel to that of the earth's axis of rotation. Flywheel 170 may be anchored to drive shaft 20 via an anchoring device 180.

Flywheel 170 may be configured to be placed at or near the top of the elevator shaft. In some examples, flywheel 170 may be configured to be placed at or near the bottom of the elevator shaft.

Flywheel clutch 190 may be configured to engage or disengage flywheel 170 from a charging device, for example, charging device 210 as described below. In some examples, when flywheel 170 is engaged with charging device 210, additional torque may be applied to flywheel 170 to increase the amount of kinetic energy stored in flywheel 170. Flywheel 170 may be engaged and/or disengaged by flywheel clutch 190 when Shabbat elevator system 10 is in Shabbat mode.

In some embodiments of the invention, when flywheel is at or near its maximum kinetic energy load, flywheel clutch 190 disengages flywheel 170 from charging device 210. In some embodiments of the invention, when elevator car 40 is in motion through an elevator shaft, flywheel clutch 190 disengages flywheel 170 to charging device 210. In some embodiments of the invention, when flywheel is not at or near its maximum kinetic energy load, flywheel clutch 190 engages flywheel 170 to charging device 210 to recharge and/or add kinetic energy to, flywheel 170. In some embodiments of the invention, when elevator car 40 is not in motion through an elevator shaft, for example, when it is at rest at a particular floor, flywheel clutch 190 may engage flywheel 170 to charging device 210 to recharge and/or add kinetic energy to, flywheel 170.

In some embodiments of the invention, flywheel 170 may be charged and/or receive additional kinetic or other forms of energy from charging device 210 or other components such that the charging is configured to be independent from the usage of elevator car 40. In some examples, the charging and/or receiving of additional kinetic or other forms of energy is not related to or a function of the actual use of elevator car 40. In some examples, the charging and/or receiving of additional kinetic energy is not related to or a function of the amount of energy consumed by elevator car 40. In some examples, the charging and/or receiving of additional kinetic energy is not related to or a function of the level of current or voltage consumed by elevator car 40 or by all or some of the other components of Shabbat elevator system 10.

Control transmission 200 may be configured to coordinate and control speed and torque of flywheel 170 to prevent unwanted or unnecessary acceleration of elevator car 40. Control transmission 200 may be configured to coordinate between charging device 210 (described, for example, below) and the momentum of flywheel 170. Control transmission 200 may include, for example, transmission gears, transmission bands, a hydraulic transmission and/or other mechanical systems for a transmission.

Engine, motor, mechanical motivator or charging device 210 may be a mechanical, electrical motor, hydraulic or other type of motor or mechanical motivator or charging device, referred to below as a motor. Charging device 210 may be configured to recharge and/or add kinetic energy to flywheel. Charging device 210 may be configured to recharge and/or add non-electrical energy to an energy storage device.

Mechanical processing unit 220 may be in communication with system processing unit 50. Mechanical processing unit 220 may employ one or a plurality of indicators, including oil pressure, air pressure water pressure and mechanical mechanisms for use in mechanically controlling components of Shabbat elevator system 10. Mechanical processing unit 220. Mechanical processing unit may be in communication with directional unit 130, coupling clutch 140, continuously variable transmission 150, drive clutch 160, flywheel 170, anchoring device 180, flywheel clutch 190, control transmission 200 and charging device 210, and transfer commands mechanically to directional unit 130, coupling clutch 140, continuously variable transmission 150, drive clutch 160, flywheel 170, anchoring device 180, flywheel clutch 190, control transmission 200, and charging device 210. Some mechanical commands may be related to braking, speed of elevator car 40, opening of doors on elevator car 140 and other operations, controls, characteristics and/or parameters of the operation of the elevator consistent with the operation of an elevator and or Shabbat elevator.

Mechanical monitoring unit 230 may inform mechanical processing unit 220. Mechanical monitoring unit may employ mechanical valves, switches, sensors, mechanical timers, and other mechanical, and in some examples, non-electrical components to measure and provide data regarding elevator car 40 including its position, direction, speed and other information related to the travel of elevator car 40.

Mechanical monitoring unit may monitor speed and position of elevator car 40 and/or other information regarding elevator car 40. In some embodiments of the invention, the mechanical monitoring unit monitors speed and other variables of other components of Shabbat elevator system 10.

FIG. 1B is a schematic illustration of the mechanism of a Shabbat elevator according to an embodiment of the invention.

In some embodiments of the invention, directional unit 130, coupling clutch 140, continuously variable transmission 150, drive clutch 160, flywheel 170, anchoring device 180, flywheel clutch 190, control transmission 200, and charging device 210 may be contained within a vacuum tank or vacuum chamber 240, the vacuum chamber being configured to limit the friction and drag on flywheel 170.

In some embodiments, a mechanical processing unit 220 and/or mechanical monitoring unit 230 may also be included with the vacuum chamber 240.

In some embodiments of the invention, fewer components may be contained within vacuum chamber 240. A vacuum pump 270 may create and/or maintain a complete or a partial vacuum in vacuum chamber 240. Vacuum pump 270 may be a turbomolecular-style pump or any other type of vacuum pump that is coupled to flywheel 170.

In some embodiments of the invention, flywheel 170 may be encased in a casing or containment unit. The encasement in the casing may be for safety reasons and may be configured to contain debris in the case of flywheel failure. The encasement may include aluminum housing or from other materials. The aluminum housing may include composite rings encircling the flywheel which serve as a soft landing zone for debris. Anchoring device 180 may function as a containment unit.

Shabbat Elevator system 10 may be configured to switch from Shabbat mode to non-Shabbat mode automatically in instances of flywheel 170 failure or in emergencies. In some examples, an emergency override switch, operated in some examples via key or via an electronic lock, or via other mechanisms, may automatically switch Shabbat elevator system 10 from a Shabbat mode to a non-Shabbat mode.

Shabbat Elevator system 10 may include duplicate and/or redundant components.

In some embodiments of the invention, when elevator car 40 brakes or slows down, the kinetic energy may be transferred back to flywheel 170.

In some embodiments of the invention, flywheel 170 and other components of Shabbat elevator system 10 may be used on days that are not Shabbat or Holidays. The use of flywheel 170 and other components of Shabbat elevator system 10 may reduce the overall energy consumption of elevator car 40. In some embodiments of the invention, flywheel 170 and other components of Shabbat elevator system 10 may be automatically engaged when there is a loss of electrical power to elevator car 40 and or other components of Shabbat elevator system 10 during standard, non-Shabbat mode operation.

In some embodiments of the invention, flywheel 170 may be constructed to resemble a hockey puck, for example, solid and of a consistent construction throughout. In some embodiments of the invention, flywheel 170 may be constructed to be doughnut-shaped concentrating most of its mass in a rim area of flywheel 170. Flywheel 170 may include a carbon-fiber composite rim, supported by a metal hub and shaft. In some embodiments of the invention, one or more flywheels may be coupled serially or in parallel.

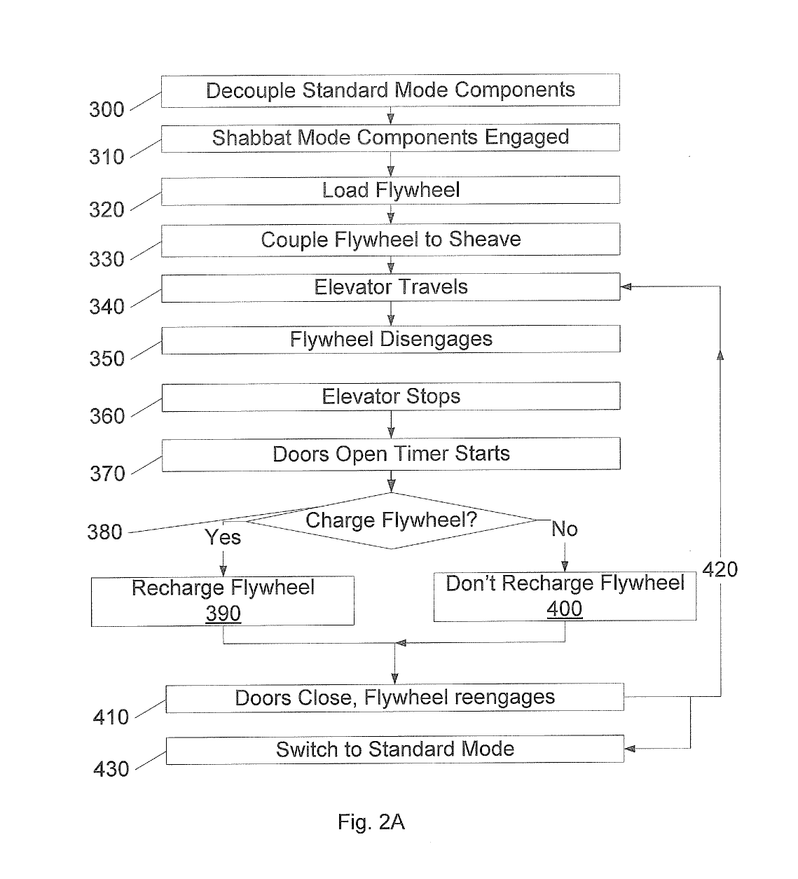

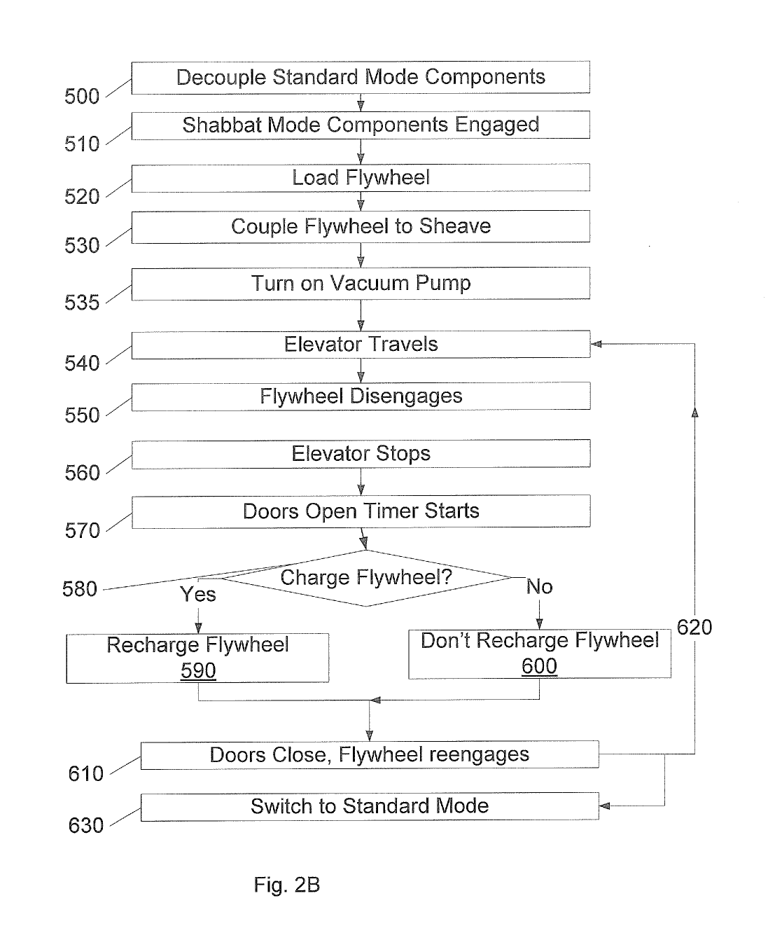

FIG. 2A is a schematic illustration of a method of employing a Shabbat elevator, according to an embodiment of the invention.

In some embodiments of the invention, during the Shabbat mode, manual and/or passenger control of an elevator car are disengaged.

Box 300 depicts the switching, either via a manual switch or automatically or via a semi-automatic process, an elevator and all of its components from a standard or weekday mode to a Shabbat mode. This depicts a portion of the method wherein components of an elevator system for use during a standard mode of operation are turned off or decoupled from the system. The decoupling from the system may include the decoupling via a clutch or a clutch system of a motor that, during the standard mode of operation, may be coupled directly or indirectly to a sheave, the sheave configured to rotate and move an elevator car in an upwards or downwards direction within an elevator shaft. In some examples, monitoring units, processing units, and or sensors may be switched off. In some examples, a portion of monitoring units, processing units and or sensors may be turned off and or taken offline.

Box 310 depicts a portion of the method wherein components of an elevator system for use during Shabbat mode are engaged. These components may include a flywheel and/or other non-electrical source of energy, a charging device, mechanical monitoring units, mechanical sensing units, mechanical emergency systems, mechanical brake systems, clutches, transmissions, couplers, decouplers and other components.

Box 320 depicts a portion of the method of an embodiment of the invention wherein a flywheel or other energy storage device is loaded and/or coupled to a motor and/or other charging device, which begins to rotate a flywheel, and wherein the flywheel begins to load and store kinetic energy. Other methods may also be employed to load and store energy mechanically or otherwise non-electronically, according to embodiments of the invention.

Box 330 depicts a portion of the method of an embodiment of the invention wherein once the flywheel and/or other energy storage device is fully or partially charged and/or spinning a percentage of its operating speed, a coupling, for example via a hydraulic valve, or via other means of the flywheel, to the sheave will engage and the flywheel will begin to rotate the sheave, typically via a transmission, the transmission typically being a continuous variable transmission. The rotation of the sheave will cause the elevator within the elevator shaft to begin to move, typically via steel or otherwise high-strength cables, in either an upward or downward direction.

Box 340 depicts a portion of the method of the embodiment of the invention wherein the elevator travels to other floors. The elevator may be traveling with or without passengers and may travel to the next floor or skip a predetermined number of floors.

Box 350 depicts a portion of the method of an embodiment of the invention wherein before the elevator car stops; a clutch or other mechanism disengages the flywheel, and/or other energy storage device from a drive shaft or from a portion of other components within the Shabbat elevator system. The disengaged flywheel may continue to spin without loosing a significant portion of its kinetic energy and without significantly straining some components of the Shabbat elevator system

Box 360 depicts a portion of the method of an embodiment of the invention wherein the elevator car travels in a direction within the elevator shaft and slows down and/or stops when a mechanical monitoring unit in communication with a mechanical processing unit triggers the car to slow and/or stop, in some embodiments via a braking system, in response to a signal indicating that a stopping point has arrived. In some embodiments of the invention, the stopping point may be every floor or level within in a multistory building. In some embodiments of the invention, the stopping point may be a subset of floors within a multistory building.

Box 370 depicts a portion of the method of an embodiment of the invention wherein a mechanical mechanism opens the elevator doors, and a timing mechanism holds the elevator at the floor and the doors open for a predetermined amount of time.

Diamond 380 depicts a portion of the method of an embodiment of the invention wherein a mechanical processing unit in communication with a mechanical monitoring unit assess whether when stopped at a floor or level, whether to decouple the flywheel and/or other energy storage device from the sheave and recharge the flywheel via a charging device, e.g., a motor, or to decouple the flywheel from the sheave, but not to connect the flywheel to the charging device.

In some embodiments of the invention, the decision as to whether to couple the flywheel to the charging device may be a random decision, such that at every floor the flywheel may or may not be coupled to the charging device, but that coupling cannot be predicted.

In some embodiments of the invention, the flywheel and/or other energy storage device may be coupled to the charging device every time the elevator car stops. In some embodiments of the invention the flywheel may be connected to the charging device after a set number of stops or after it has traveled a set distance. This determination may be made by the mechanical processing unit in communication with a mechanical monitoring unit. In some embodiments of the invention, the mechanical processing unit in communication with a mechanical monitoring unit may determine the remaining kinetic energy within the flywheel and determine whether the flywheel should be connected to and charged by the charging device. The kinetic energy of the flywheel can be calculated by the equation:

Eₖ=½Iω² where:

Where:

Eₖ is the stored energy in a flywheel

I is the moment of inertia; and,

ω is the rotational or angular velocity of the flywheel, e.g., in rpm or radiants per second.

The moment of inertia I can be calculated as:

I=kmr² where:

k is the inertial constant and is shape dependent;

in is the mass of the flywheel; and,

r is the radius of the flywheel.

Box 390 depicts a portion of the method of an embodiment of the invention wherein the flywheel and/or other energy storage device is disengaged by a clutch and wherein the flywheel is recharged by a charging device, e.g., a motor.

Box 400 depicts a portion of the method of an embodiment of the invention wherein the flywheel is not disengaged by a clutch and wherein the flywheel and/or other energy storage device is not recharged by a charging device.

Box 410 depicts a portion of the method of an embodiment of the invention wherein, after a predetermined period of time, the doors to the elevator car close, and the flywheel and/or other energy storage device disengages from the charging device, if it was coupled to the charging device. In some embodiments of the invention, the flywheel and/or other energy storage device may be recharged by the charging device each time the elevator car stops and/or disengages by a clutch during the Shabbat mode.

In some embodiments of the invention, the flywheel and/or other energy storage device reengages with other components of the elevator system, including the sheath, the brakes on the elevator are released, and the elevator continues to move. In some examples, the predetermined time may vary depending on factors such as location of the floor, whether the floor is the main floor or the lobby, and other factors.

Arrow 420 depicts that the method loops back to box 340, where the elevator continues to travel through the elevator shaft.

Box 430 depicts a portion of the method of an embodiment of the invention wherein after a predetermined period of time, for example after the duration of the Shabbat or a Holiday, the Shabbat mode switches off, either automatically, semi-automatically or via human intervention. When Shabbat mode is turned off, the flywheel disengages from the drive shaft and or other components of the Shabbat elevator system and the motor used during the standard mode of the elevator is reengaged with the drive shaft. The electrical sensors, switches and interfaces are reengaged including buttons both within and outside of the elevator car.

FIG. 2B is a schematic illustration of a method of employing a Shabbat elevator, according to an embodiment of the invention.

In some embodiments of the invention, during the Shabbat mode, manual and/or passenger control of an elevator car are disengaged.

Box 500 depicts the switching, either via a manual switch or automatically or via a semi-automatic process, an elevator and all of its components from a standard or weekday mode to a Shabbat mode.

Box 510 depicts a portion of the method wherein components of an elevator system for use during a standard mode of operation are turned off or decoupled from the system. The decoupling from the system may include the decoupling via a clutch or a clutch system of a motor that, during the standard mode of operation may be coupled directly or indirectly to a sheave, the sheave configured to rotate and move an elevator car in an upwards or downwards direction within an elevator shaft. In some examples, monitoring units, processing units, and or sensors may be switched off. In some examples, a portion of monitoring units, processing units and or sensors may be turned off and or taken offline.

Box 520 depicts a portion of the method wherein components of an elevator system are put online after a switch to Shabbat mode. These components may include a flywheel, a charging device, e.g., a motor, mechanical monitoring units, mechanical sensing units, mechanical emergency systems, mechanical brake systems, clutches, transmissions, couplers, decouplers and other components.

Box 530 depicts a portion of the method of an embodiment of the invention wherein a motor begins to rotate a flywheel, and wherein the flywheel begins to load and store kinetic energy. Other energy storage devices may be used in lieu of or in addition to a flywheel.

Box 535 depicts a portion of the method of an embodiment of the invention wherein a vacuum pump is be turned on or engaged at this point. The vacuum pump may be turned on later or earlier in the method. In some embodiments of the invention, the vacuum pump may be engaged before the flywheel begins to load energy.

Box 540 depicts a portion of the method of an embodiment of the invention wherein once the flywheel and/or other energy storage device is fully or partially charged and/or spinning a percentage of its operating speed, a coupling of the flywheel to the sheave will engage and the flywheel will begin to rotate the sheave, typically via a transmission, the transmission typically being a continuous variable transmission. The rotation of the sheave will cause the elevator within the elevator shaft to begin to move, typically via steel or otherwise high-strength cables, in either an upward or downward direction.

Box 550 depicts a portion of the method of an embodiment of the invention wherein before the elevator car stops; a clutch disengages the flywheel and/or other energy storage device from a drive shaft or from a portion of other components within the Shabbat elevator system. The disengaged flywheel may continue to spin without loosing a significant portion of its kinetic energy and without significantly straining some components of the Shabbat elevator system

Box 560 depicts a portion of the method of an embodiment of the invention wherein the elevator car travels in a direction within the elevator shaft and slows down and/or stops when a mechanical monitoring unit in communication with a mechanical processing unit triggers the car to slow and/or stop, in some embodiments via a braking system, in response to a signal indicating that a stopping point has arrived. In some embodiments of the invention, the stopping point may be every floor or level within in a multistory building. In some embodiments of the invention, the stopping point may be a subset of floors within a multistory building.

Box 570 depicts a portion of the method of an embodiment of the invention wherein a mechanical mechanism opens the elevator doors, and a timing mechanism holds the elevator at the floor and the doors open for a predetermined amount of time.

Diamond 580 depicts a portion of the method of an embodiment of the invention wherein a mechanical processing unit in communication with a mechanical monitoring unit assess whether when stopped at a floor or level, whether to decouple the flywheel and/or other energy storage device from the sheave and recharge the flywheel via a charging device, or to decouple the flywheel from the sheave, but not to connect the flywheel to the charging device.

In some embodiments of the invention, the decision as to whether to couple the flywheel and/or other energy storage device to the charging device may be a random decision, such that at every floor the flywheel may or may not be coupled to the charging device, but that coupling cannot be predicted.

In some embodiments of the invention, the flywheel and/or other energy storage device may be coupled to the charging device every time the elevator car stops. In some embodiments of the invention, the flywheel may be connected to the charging device after a set number of stops or after travelling a set distance. This determination may be made by the mechanical processing unit in communication with a mechanical monitoring unit. In some embodiments of the invention, the mechanical processing unit in communication with a mechanical monitoring unit may determine the remaining kinetic energy within the flywheel and determine whether the flywheel should be connected to and charged by the charging device.

Box 590 depicts a portion of the method of an embodiment of the invention wherein the flywheel and/or other energy storage device is disengaged by a clutch and wherein the flywheel is recharged by a charging device.

Box 600 depicts a portion of the method of an embodiment of the invention wherein the flywheel and/or other energy storage device is not disengaged by a clutch and wherein the flywheel is not recharged by a charging device.

Box 610 depicts a portion of the method of an embodiment of the invention wherein, after a predetermined period of time, the doors to the elevator car close, the flywheel and/or other energy storage device disengages from the charging device, if it was coupled to the charging device, the flywheel reengages with other components of the elevator system, including the sheath, the brakes on the elevator are released, and the elevator continues to move. In some examples, the predetermined time may vary depending on factors such as location of the floor, whether the floor is the main floor or the lobby and other factors.

Arrow 620 depicts that the method loops back to box 340, where the elevator continues to travel through the elevator shaft.

Box 630 depicts a portion of the method of an embodiment of the invention wherein after a predetermined period of time, for example, after the duration of the Shabbat or a Holiday, the Shabbat mode switches off, either automatically, semi-automatically or via human intervention. When Shabbat mode is turned off, the flywheel disengages from the drive shaft and or other components of the Shabbat elevator system, and the motor used during the standard mode of the elevator is reengaged with the drive shaft. The electrical sensors, switches and interfaces are reengaged including buttons both within and outside of the elevator car. The vacuum pump may be turned off at this point.

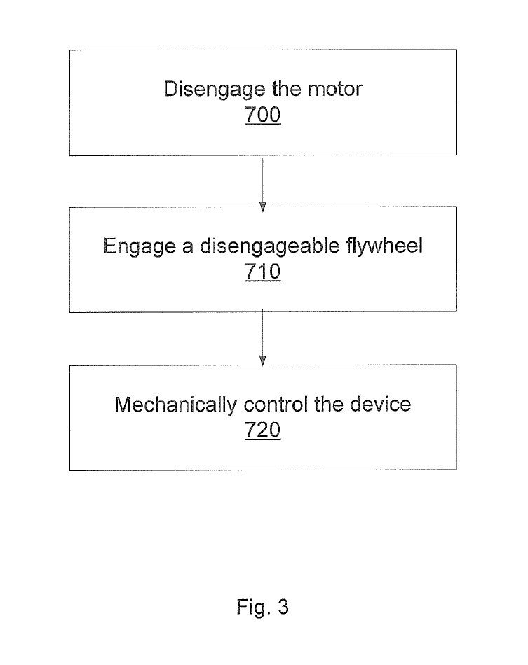

FIG. 3 is a schematic illustration of a method for operating a Shabbat elevator, according to an embodiment of the invention.

A Shabbat elevator or another transportation device may be configured to operate under at least a first condition and a second condition, wherein the transportation device is configured to travel without an additional input of an electrical current during the second condition. In some embodiments of the invention, a transportation device is configured to travel without any human induced changes in electric current or voltage associated with Shabbat elevator system 10. In some embodiments of the invention, the first condition is when it is not the Shabbat or a Jewish Holiday. In some embodiments of the invention, the second condition is when it is the Shabbat or a Jewish Holiday.

Box 700 depicts a step in the method of operating a Shabbat elevator, wherein this step includes disengaging a disengageable motor, the motor configured to operate during the first condition, e.g., when it is not the Shabbat or a Jewish Holiday, wherein the operation of the motor supports the travelling of a transportation device.

Box 710 depicts the step wherein a disengageable flywheel is engaged to a drive shaft or other component of a transportation system during all or a portion of a second condition, e.g., when it is the Shabbat or a Jewish Holiday. When the disengageable flywheel and/or other energy storage device is operating the transportation device, under the second condition it may be coupled to the transportation device for example, via a continuous variable transmission. The disengageable flywheel may, in some embodiments of the invention, be automatically recharged by a charging device, e.g., a second disengageable motor when the flywheel is disengaged during the second condition. The disengageable flywheel may be disengaged during the second condition at set intervals defined in some examples of the invention, by distance or time traveled or in some embodiments of the invention, determined randomly or by other criteria.

Box 720 depicts the use of a mechanical control unit to mechanically control the motion of the transportation device. The mechanical control unit may mechanically control (e.g., without the input of electricity) with the input of information from sensors. The sensors may be mechanical in their use and may transmit the information mechanically to the mechanical control unit.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system comprising:
a transportation device configured to operate under at least a first condition and a second condition, wherein the transportation device is configured to operate without a human induced change in an electrical current during the second condition;
a disengageable motor configured to operate the transportation device under the first condition and coupled to the transportation device;
a disengageable energy storage device configured to power the operation of the transportation device under the second condition and coupled to the transportation device, wherein the disengageable energy storage device may be automatically recharged by a charging device when the energy storage device is disengaged; and,
a mechanical processing unit for mechanically controlling the operation of the transportation device.

2. The system of claim 1, wherein the energy storage device is a flywheel.

3. The system of claim 1, further comprising a mechanical monitoring unit configured to mechanically monitor aspects of the transportation device.

4. The system of claim 1, further comprising a continuous variable transmission for controlling a speed of the transportation device.

5. The system of claim 1, wherein the disengageable energy storage device is configured to be recharged by a charging device when the disengageable energy storage device disengages.

6. The system of claim 1, wherein the disengageable energy storage device is configured to be disengaged when the transportation device is at rest.

7. The system of claim 1, wherein the disengageable energy storage device is configured to be recharged by a disengageable charging device after the transportation device has traveled a set distance.

8. The system of claim 1, wherein the mechanical processing unit employs one or a plurality of indicators selected from the group consisting of oil pressure, water pressure, air pressure, and mechanisms.

9. The system of claim 1, wherein a portion of the system is enclosed in a vacuum tank.

10. The system of claim 3, wherein the mechanical monitoring unit monitors speed and position of the transportation device using one or a plurality of indicators selected from the group consisting of water pressure, oil pressure, air pressure, and mechanical mechanisms.

11. A method comprising:
disengaging a motor configured to operate a transportation device under a first condition;
engaging a disengageable energy storage device to operate the transportation device under a second condition, wherein the disengageable energy storage device may be automatically recharged by a charging device when the energy storage device is disengaged; and,
mechanically controlling the operation of the transportation device.

12. The method of claim 11, wherein the energy storage device is a flywheel.

13. The method of claim 11, further comprising mechanically monitoring the operation of the transportation device.

14. The method of claim 11, further comprising controlling a speed of the transportation device.

15. The method of claim 11, further comprising disengaging the disengageable the energy storage device when the transportation device is at rest.

16. The method of claim 11, further comprising recharging the energy storage device by a charging device when the disengageable energy storage device disengages.

17. The method of claim 11, further comprising recharging the disengageable energy storage device is recharged by a charging device after the transportation device has traveled a set distance or a set time has passed.

18. The method of claim 11, wherein the mechanical processing unit employs one or a plurality of indicators selected from the group consisting of oil pressure, water pressure, air pressure, and mechanical mechanisms.

19. The method of claim 11, wherein a vacuum tank creates at least a partial vacuum around the disengageable energy storage device.

20. The method of claim 13, wherein the mechanical monitoring unit monitors speed and position of the transportation device using one or a plurality of indicators selected from the group consisting of water pressure, oil pressure, air pressure, and mechanical mechanisms.
